(19) United States
(12) Patent Application Publication
(10) Pub. No.: US 2012/0024414 A1
(43) Pub. Date: Feb. 2, 2012

(54) AIR DUCT

(75) Inventor: An-Gang Liang, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 12/859,286

(22) Filed: Aug. 19, 2010

(30) Foreign Application Priority Data
Jul. 28, 2010 (CN) 201010239080.8

(51) Int. Cl. F16L 9/00

(52) U.S. Cl. 138/177

(57) ABSTRACT

An air duct is installed on a circuit board, and shields a number of indicator lights mounted on the circuit board. The air duct defines a number of viewing windows aligned with the corresponding indicator lights. A transparent film covers each of the viewing windows.

### BACKGROUND 1. Technical Field

The present disclosure relates to an air duct.

2. Description of Related Art

Air ducts installed on circuit boards are generally made of opaque material. As a result, some indicator lights mounted on the circuit board may be obscured, which is inconvenient. However, air ducts made of transparent material are more costly. As a result, an air duct to overcome the above deficiencies is needed.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of an air duct, together with a circuit board and a plurality of electronic devices.

FIG. 2 is an exploded, isometric view of the air duct with the circuit board and the electronic devices of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

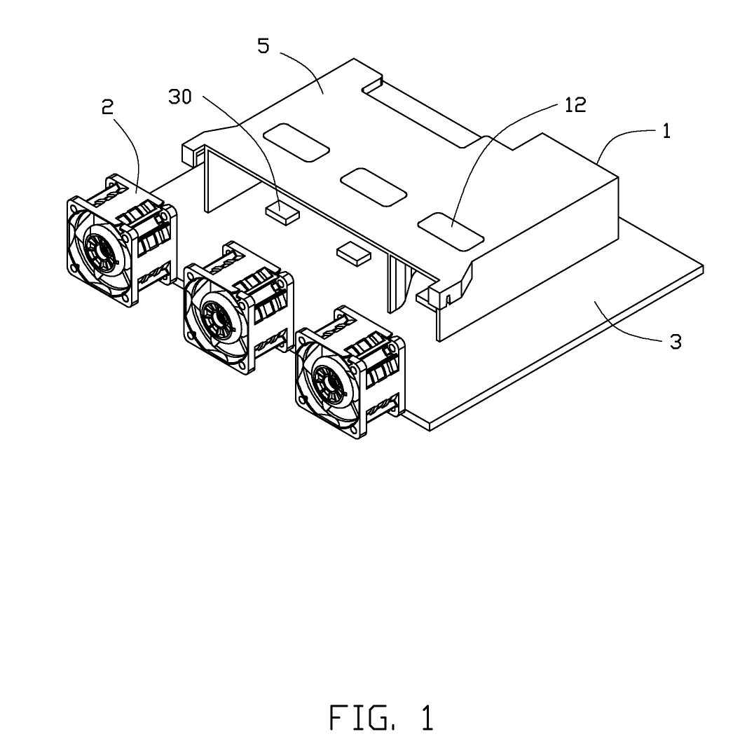

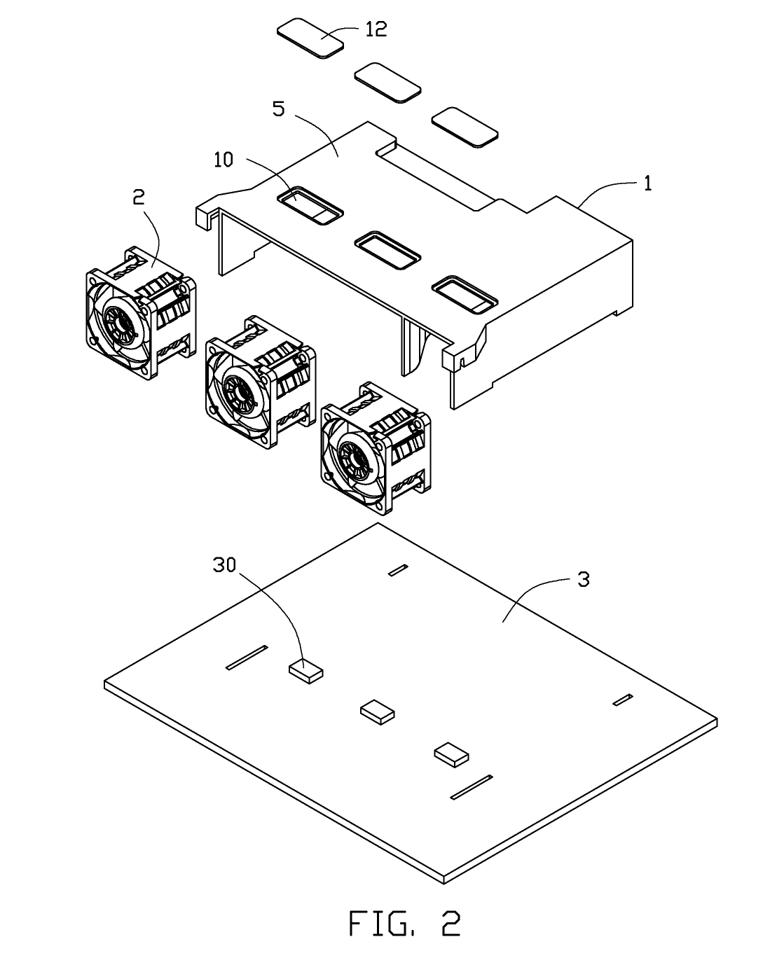

Referring to FIG. 1 and FIG. 2, an exemplary embodiment of an air duct 1 is used to direct airflow for heat dissipation without obscuring a plurality of indicator lights 30 mounted on a circuit board 3, which can indicate the working status of a plurality of corresponding electronic devices 2.

The air duct 1 includes a main body 5 installed on the circuit board 3 and shielding the indicator lights 30, and a plurality of transparent films 2. The air duct 1 defines a plurality of viewing windows 10 aligning with the corresponding indicator lights 30 in a top of the main body 5. The transparent film 12 covers the corresponding viewing windows 10.

In this embodiment, the electronic devices 2 are fans, the indicator lights 30 are light-emitting diodes.

In this embodiment, the transparent films 12 are made of polyester film.

It is believed that the present embodiments and their advantages will be understood from the foregoing description, and they will be apparent that various changes may be made thereto without departing from the spirit and scope of the description or sacrificing all of their material advantages, the examples hereinbefore described merely being exemplary embodiment.

What is claimed is:

1. An air duct comprising:
a main body shield a plurality of indicator lights mounted on a circuit board, the main body defining a plurality of viewing windows aligning with the corresponding indicator lights; and
a plurality of transparent films covering the corresponding viewing windows.

2. The air duct of claim 1, wherein each of the plurality of transparent films is made of polyester film.

3. The air duct of claim 1, wherein the plurality of viewing windows are defined in a top of the air duct in alignment with the plurality of indicator lights.
